(19) United States
(12) Patent Application Publication
(10) Pub. No.: US 2026/0177427 A1
(43) Pub. Date: Jun. 25, 2026

(54) SPECTROSCOPIC DEVICE AND WAVELENGTH CORRECTION METHOD

(71) Applicant: Konica Minolta, Inc., Tokyo (JP)

(72) Inventor: Toshio KAWANO, Tokyo (JP)

(21) Appl. No.: 19/127,262

(22) PCT Filed: Oct. 16, 2023
(86) PCT No.: PCT/JP2023/037373

§ 371 Date: May 5, 2025

(30) Foreign Application Priority Data
Nov. 7, 2022 (JP) 2022-178276

(51) Int. Cl. G01J 3/02; G01J 3/28

(52) U.S. Cl. CPC G01J 3/027; G01J 3/021; G01J 3/2823

(57) ABSTRACT

The spectroscopic device may includes: a correction light source; an optical filter that transmits a light ray of a specific wavelength band among light rays from the correction light source; an entrance slit on which light of interest and correction light that has been emitted from the correction light source and has passed through the optical filter are incident; dispersion means for dispersing, into dispersion images for each wavelength, the light of interest that has passed through the entrance slit during measurement of the light of interest and the correction light that has passed through the entrance slit during wavelength correction; a light receiving sensor that receives the dispersion images; and arithmetic control means that, during the wavelength correction, obtains a shift amount of a light receiving position where the dispersion image based on the correction light is received from an initial position on the light receiving sensor and corrects wavelength.

### CROSS REFERENCE TO RELATED APPLICATIONS

This is the U.S. national stage of application No. PCT/JP2023/037373, filed on Oct. 16, 2023. Priority under 35 U.S.C. § 119(a) and 35 U.S.C. § 365(b) is claimed from Japanese Application No. 2022-178276, filed Nov. 7, 2022, the disclosure of which is also incorporated herein by reference.

### TECHNICAL FIELD

The present invention relates to a spectroscopic device and a wavelength correction method with which it is possible to measure a spectral intensity distribution of light of interest and correct a wavelength shift.

### BACKGROUND ART

Conventionally, it is often the case that a polychromator which is capable of measuring all the measurable wavelength bands at the same time without providing a movable member and which thus has high usability of a flux of light is used as a dispersion method in a spectroscopic device for measuring a spectral intensity distribution of light of interest. Such a polychromator includes an entrance slit on which light of interest is incident, a diffraction grating for dispersing the incident light according to wavelengths, and a light receiving sensor array that receives each of dispersion images and detects the light flux intensity of the dispersion image. These constituent elements which are supported on a structural member unavoidably have time-dependent and thermal changes in relative position of the constituent elements. In a case where a spectroscope of a light dispersive type such as a polychromator is used, the wavelength accuracy is susceptible to a change in relative position of the constituent elements. Therefore, it is necessary to check and correct the wavelength accuracy in order to maintain high accuracy.

As a method for correcting wavelengths, a method illustrated in FIG. 7 is proposed in Patent Literature 1.

In FIG. 7, one monochromatic ray for correction is allowed to enter a polychromator. The shift amounts of a first order dispersion image (first order diffraction image) of a wavelength λ1 and a second order dispersion image (second order diffraction image) of a wavelength λ2 from an initial position are defined as d1 and d2, respectively.

The shift amount d1 includes a wavelength shift amount dx due to time-dependent and thermal changes of the polychromator and a shift amount dλ of the wavelength λ1 of the monochromatic ray for correction. That is, d1=dx+dλ.

Similarly, the shift amount d2 includes a wavelength shift amount dx due to time-dependent and thermal changes of the polychromator and a shift amount 2*dλ of the wavelength λ2 of the monochromatic ray for correction. That is, d2=dx+2*dλ.

Then, from the two equations d1=dx+dλ and d2=dx+2*dλ, the wavelength shift amount dx of the polychromator is obtained from dx=2*d1−d2, and the wavelengths are corrected based on this shift amount.

The shift amounts dλ and 2dλ of the wavelengths λ1 and λ2 of the monochromatic ray for correction are variations caused by temperature or the like when a monochromatic LED is used as a light source for the monochromatic ray for correction. The wavelength change of the light source is noise. The wavelength correction method described in Patent Literature 1 is based on the premise that, when the wavelength change of the monochromatic ray for correction is dλ, the wavelength change contributes as the wavelength change dλ to the shift amount d1 of the first order dispersion image, whereas the wavelength change contributes as 2*dλ to the shift amount d2 of the second order dispersion image in principle. In the wavelength correction method described in Patent Literature 1, the remaining wavelength shift amount dx of the polychromator is obtained as described above.

In addition, Patent Literature 2 proposes a correction method using an emission line of a Ne lamp or the like. Specifically, the correction method includes using a light source for wavelength shift correction that emits light for wavelength shift correction including a plurality of emission lines for wavelength shift correction. The correction method further includes using a spectrometer to be subjected to wavelength shift correction, the spectrometer including a spectroscopic section that receives, with a plurality of photoelectric conversion elements arranged in a direction of dispersion, respective rays of dispersed spectral light obtained by dispersing incident light according to wavelength, and outputs electric signals corresponding to light intensities of the respective rays of dispersed spectral light. In a case where the light for wavelength shift correction is measured with the spectrometer to be subjected to wavelength shift correction as incident light, an amount of change of wavelength is obtained on the basis of electric signals output from a plurality of specific photoelectric conversion elements that receives a plurality of emission lines for wavelength shift correction among the plurality of photoelectric conversion elements. At least one of the plurality of specific photoelectric conversion elements receives two or more emission lines for wavelength shift correction from among a plurality of emission lines for wavelength shift correction.

### CITATION LIST

### Patent Literature

Patent Literature 1: JP 3702889 B2

Patent Literature 2: JP 6992812 B2

### SUMMARY OF INVENTION

### Technical Problem

In the correction method described in Patent Literature 1, when the wavelength shift amount dx due to time-dependent and thermal changes of the polychromator is uniform regardless of the wavelength, the wavelength can be corrected with high accuracy. However, when the shift amount dx of the polychromator varies depending on wavelength, a correction residual remains.

For example, when the diffraction grating serving as a dispersion element, which is formed of a material having a large linear expansion coefficient such as resin, expands or contracts due to a temperature change, the groove pitch of the diffraction grating changes. In this case, the dispersion image on the light receiving sensor is enlarged or reduced in the wavelength direction, resulting in that the wavelength shift amount is not uniform. Therefore, the method described in Patent Literature 1 has a problem that it is not possible to obtain an accurate correction effect.

Further, in the correction method described in Patent Literature 2, a wavelength shift amount is obtained by focusing on a specific emission line, and a uniform wavelength shift amount is given to all wavelengths. Therefore, the correction method described in Patent Literature 2 also has a problem that it is not possible to obtain an accurate correction effect as in the correction method described in Patent Literature 1. Furthermore, with a recent decrease in demand for gas discharge tube lamps such as Ne lamps, there is also a risk that a desired lamp is hardly available in the future.

An object of the present invention is to provide a spectroscopic device and a wavelength correction method with which it is possible to accurately correct a wavelength when there are both a wavelength change caused by a change in temperature of a light source for wavelength correction and a wavelength change caused by time-dependent and thermal changes of a polychromator. Another object of the present invention is to provide a spectroscopic device and a wavelength correction method with which it is not necessary to use a gas discharge tube lamp such as a Ne lamp as a correction light source.

### Solution to Problem

The above objects are achieved by the following means.
(1) A spectroscopic device including:
at least one correction light source;
at least one optical filter that transmits a light ray of a specific wavelength band among light rays from the correction light source;
at least one entrance slit on which light of interest and correction light that has been emitted from the correction light source and has passed through the optical filter are incident;
dispersion means that disperses, into dispersion images for each wavelength, the light of interest that has passed through the entrance slit during measurement of the light of interest and the correction light that has passed through the entrance slit during wavelength correction;
a light receiving sensor that receives the dispersion images for each wavelength by the dispersion means and outputs an electric signal corresponding to an intensity of received light; and
arithmetic control means that, during the wavelength correction, obtains a shift amount of a light receiving position where the dispersion image based on the correction light is received from an initial position on the light receiving sensor and corrects wavelength based on the shift amount.
(2) The spectroscopic device according to the item 1 described above, wherein the arithmetic control means obtains a shift amount for another wavelength from a shift amount of a light receiving position where each of a plurality of dispersion images is received from an initial position on the light receiving sensor for one or a plurality of the correction light sources.
(3) The spectroscopic device according to the item 1 described above, wherein the arithmetic control means obtains a shift amount for another wavelength from a shift amount of a light receiving position where a first order dispersion image is received from an initial position on the light receiving sensor and a shift amount of a light receiving position where a second order dispersion image is received from an initial position on the light receiving sensor for one or a plurality of the correction light sources.
(4) The spectroscopic device according to any one of the items 1 to 3 described above, wherein the optical filter is a bandpass filter having at least one spectral transmission band.
(5) The spectroscopic device according to any one of the items 1 to 3 described above, wherein the optical filter is a sharp cut filter.
(6) The spectroscopic device according to the item 4 described above, wherein the arithmetic controller determines a light receiving position of any one of a peak wavelength, a central wavelength, and a centroid wavelength of the spectral transmission band as the light receiving position where the dispersion image is received.
(7) The spectroscopic device according to the item 4 described above, wherein the arithmetic controller determines a light receiving position of a cut wavelength of the spectral transmission band as the light receiving position where the dispersion image is received.
(8) The spectroscopic device according to the item 5 described above, wherein the arithmetic controller determines a light receiving position of a cut wavelength of the sharp cut filter as the light receiving position where the dispersion image is received.
(9) The spectroscopic device according to any one of the items 1 to 3 described above, further including switching means that allows the light of interest to enter the entrance slit during the measurement of the light of interest and allows the correction light to enter the entrance slit during the wavelength correction.
(10) The spectroscopic device according to the item 9 described above, further including
a reflective plate disposed so as to be freely inserted into and retracted from an optical path of the light of interest entering the entrance slit, wherein
the switching means retracts the reflective plate from the optical path of the light of interest during the measurement of the light of interest and advances the reflective plate into the optical path of the light of interest during the wavelength correction so that the correction light is reflected by the reflective plate to the entrance slit.
(11) The spectroscopic device according to the item 10 described above, wherein the reflective plate is a diffuse reflective plate or a mirror.
(12) The spectroscopic device according to the item 9 described above, further including:
a light receiving/diffusing plate disposed in an optical path of the light of interest entering the entrance slit, the light receiving/diffusing plate transmitting the light of interest and diffusing and reflecting the correction light; and a light shielding plate disposed so as to be freely inserted into and retracted from the optical path of the light of interest at an upstream side of the light receiving/diffusing plate, wherein
the switching means retracts the light shielding plate from the optical path of the light of interest during the measurement of the light of interest and advances the light shielding plate into the optical path of the light of interest during the wavelength correction.
(13) A wavelength correction method including:
a transmission step of transmitting a light ray of a specific wavelength band among light rays from at least one correction light source through at least one optical filter;
an incidence step of allowing light of interest to enter at least one entrance slit during measurement of the light of interest and allowing correction light that has been emitted from the correction light source and has transmitted through the optical filter to enter the entrance slit during wavelength correction;
a dispersion step of dispersing the light of interest or the correction light passing through the entrance slit into dispersion images for each wavelength;
a light receiving step of receiving the dispersion images for each wavelength in the dispersion step by a light receiving sensor and outputting an electric signal corresponding to an intensity of received light; and
an arithmetic control step of obtaining a shift amount of a light receiving position where the dispersion image based on the correction light is received from an initial position on the light receiving sensor during the wavelength correction, and correcting wavelength based on the shift amount.
(14) The wavelength correction method according to the item 13 described above, wherein the arithmetic control step includes obtaining a shift amount for another wavelength from a shift amount of a light receiving position where each of a plurality of dispersion images is received from an initial position on the light receiving sensor for one or a plurality of the correction light sources.
(15) The wavelength correction method according to the item 13 described above, wherein the arithmetic control step includes obtaining a shift amount for another wavelength from a shift amount of a light receiving position where a first order dispersion image is received from an initial position on the light receiving sensor and a shift amount of a light receiving position where a second order dispersion image is received from an initial position on the light receiving sensor for one or a plurality of the correction light sources.
(16) The wavelength correction method according to any one of the items 13 to 15 described above, wherein the optical filter is a bandpass filter having at least one spectral transmission band.
(17) The wavelength correction method according to any one of the items 13 to 15 described above, wherein the optical filter is a sharp cut filter.
(18) The wavelength correction method according to the item 16 described above, wherein the arithmetic control step includes determining a light receiving position of any one of a peak wavelength, a central wavelength, and a centroid wavelength of the spectral transmission band as the light receiving position where the dispersion image is received.
(19) The wavelength correction method according to the item 16 described above, wherein the arithmetic control step includes determining a light receiving position of a cut wavelength of the spectral transmission band as the light receiving position where the dispersion image is received.
(20) The wavelength correction method according to the item 17 described above, wherein the arithmetic control step includes determining a light receiving position of a cut wavelength of the sharp cut filter as the light receiving position where the dispersion image is received.
(21) The wavelength correction method according to any one of the items 13 to 15 described above, further including a switching step of allowing the light of interest to enter the entrance slit during the measurement of the light of interest and allowing the correction light to enter the entrance slit during the wavelength correction.
(22) The wavelength correction method according to the item 21 described above, wherein
the spectroscopic device includes a reflective plate disposed so as to be freely inserted into and retracted from an optical path of the light of interest entering the entrance slit, and
the switching step includes retracting the reflective plate from the optical path of the light of interest during the measurement of the light of interest and advancing the reflective plate into the optical path of the light of interest during the wavelength correction so that the correction light is reflected by the reflective plate to the entrance slit.
(23) The wavelength correction method according to the item 22 described above, wherein the reflective plate is a diffuse reflective plate or a mirror.
(24) The wavelength correction method according to the item 21 described above, wherein
the spectroscopic device includes: a light receiving/diffusing plate disposed in an optical path of the light of interest entering the entrance slit, the light receiving/diffusing plate transmitting the light of interest and diffusing and reflecting the correction light; and a light shielding plate disposed so as to be freely inserted into and retracted from the optical path of the light of interest at an upstream side of the light receiving/diffusing plate, and
the switching step includes retracting the light shielding plate from the optical path of the light of interest during the measurement of the light of interest and advancing the light shielding plate into the optical path of the light of interest during the wavelength correction.

### Advantageous Effects of Invention

According to the invention set forth in the items (1) and (13) described above, the light of interest enters at least one entrance slit during the measurement of the light of interest. During the wavelength correction, correction light of a specific wavelength band which has passed through the at least one optical filter among light rays from at least one correction light source enters the entrance slit. The light of interest or the correction light passing through the entrance slit is dispersed into dispersion images for each wavelength, and the dispersion images are received by the light receiving sensor. Then, during the wavelength correction, a shift amount of the light receiving position where the dispersion image based on the correction light is received from the initial position on the light receiving sensor is obtained, and the wavelength correction is performed based on the obtained shift amount.

That is, at least one optical filter which transmits only light of a specific wavelength band among light rays from the wavelength correction light source is disposed, and the light of a specific wavelength band transmitted through the optical filter enters the entrance slit at the time of wavelength correction. Therefore, even if a wavelength change occurs in the light from the correction light source due to a temperature change or the like, the wavelength of light transmitted through the optical filter becomes constant without being affected by the temperature change. Then, a shift amount of the light receiving position where the dispersion image based on the correction light is received from the initial position on the light receiving sensor is obtained. This shift amount does not include an influence of the wavelength change associated with the temperature change, and includes only a shift amount generated due to time-dependent and thermal changes of a polychromator. Therefore, highly accurate correction is performed.

In addition, since it is not necessary to use a gas discharge tube lamp such as a Ne lamp as the correction light source, there is no risk that the correction light source is hardly available.

According to the invention set forth in the items (2) and (14) described above, the following effects are attained. That is, a shift amount that is highly accurate without being affected by time-dependent and thermal changes of the polychromator is obtained for a plurality of wavelengths from a shift amount of a light receiving position where each of a plurality of dispersion images is received from an initial position on the light receiving sensor for one or a plurality of correction light sources. Consequently, highly accurate wavelength correction is performed. Then, linear interpolation, polynomial interpolation, extrapolation processing, or the like, for example, is performed using the obtained shift amounts for the plurality of wavelengths, and thus shift amounts for the other wavelengths for which the wavelength shift amounts are not obtained are estimated with high accuracy. Therefore, highly accurate wavelength correction is performed for other wavelengths as well.

According to the invention set forth in the items (3) and (15) described above, the following effects are attained. That is, a shift amount for another wavelength is obtained from a shift amount of a light receiving position where a first order dispersion image is received from an initial position on the light receiving sensor and a shift amount of a light receiving position where a second order dispersion image is received from an initial position on the light receiving sensor for one or a plurality of correction light sources.

According to the invention set forth in the items (4) and (16) described above, the optical filter is a bandpass filter having at least one spectral transmission band, whereby the optical filter can transmit light of a specific wavelength band among light rays from the correction light source.

According to the invention set forth in the items (5) and (17) described above, the optical filter is a sharp cut filter, whereby the optical filter can transmit light of a specific wavelength band among light rays from the correction light source.

According to the invention set forth in the items (6) and (18) described above, the wavelength represented by any of a peak wavelength, a central wavelength, and a centroid wavelength is corrected.

According to the invention set forth in the items (7) and (19) described above, a light receiving position of a cut wavelength of the spectral transmission band is determined as the light receiving position where the dispersion image is received, whereby the wavelength correction amount can be accurately obtained.

According to the invention set forth in the items (8) and (20) described above, a light receiving position of a cut wavelength of the sharp cut filter is determined as the light receiving position where the dispersion image is received, whereby the wavelength correction amount can be accurately obtained.

According to the invention set forth in the items (9) and (21) described above, the light to enter the entrance slit is switched such that the light of interest enters the entrance slit at the time of measurement of the light of interest and the correction light enters the entrance slit at the time of wavelength correction.

According to the invention set forth in the items (10) and (22) described above, the reflective plate is retracted from the optical path of the light of interest at the time of measurement of the light of interest, and the reflective plate is advanced into the optical path of the light of interest at the time of wavelength correction so that the correction light is reflected by the reflective plate to the entrance slit. Thus, the wavelength shift amount is reliably obtained at the time of wavelength correction.

According to the invention set forth in the items (11) and (23) described above, the reflective plate is a diffuse reflective plate or a mirror, whereby the correction light is reliably reflected by the reflective plate to the entrance slit at the time of wavelength correction.

According to the invention set forth in the items (12) and (24) described above, the light shielding plate is retracted from the optical path of the light of interest at the time of measurement of the light of interest and the light shielding plate is advanced into the optical path of the light of interest at the time of wavelength correction, whereby the measurement of the light of interest and the wavelength correction are switched.

### BRIEF DESCRIPTION OF DRAWINGS

FIG. 1A and FIG. 1B are diagrams illustrating a configuration of a spectroscopic device according to an embodiment of the present invention, in which FIG. 1A is a diagram illustrating a state at the time of measurement of light of interest, and FIG. 1B is a diagram illustrating a state at the time of wavelength correction.

FIG. 2 is a diagram illustrating an example of an emission spectrum of a correction light source and a transmission spectrum of an optical filter.

FIG. 3A to FIG. 3C are explanatory diagrams of wavelength correction performed using a wideband bandpass filter as the optical filter.

FIG. 4A to FIG. 4 are explanatory diagrams of wavelength correction performed using a sharp cut filter as the optical filter.

FIG. 5A and FIG. 5B are diagrams illustrating a configuration of a spectroscopic device according to another embodiment of the present invention, in which FIG. 5A is a diagram illustrating a state at the time of measurement of light of interest, and FIG. 5B is a diagram illustrating a state at the time of wavelength correction.

FIG. 6A and FIG. 6B are diagrams illustrating a configuration of a spectroscopic device according to still another embodiment of the present invention, in which FIG. 6A is a diagram illustrating a state at the time of measurement of light of interest, and FIG. 6B is a diagram illustrating a state at the time of wavelength correction.

FIG. 7 is a diagram for describing a conventional method of wavelength correction.

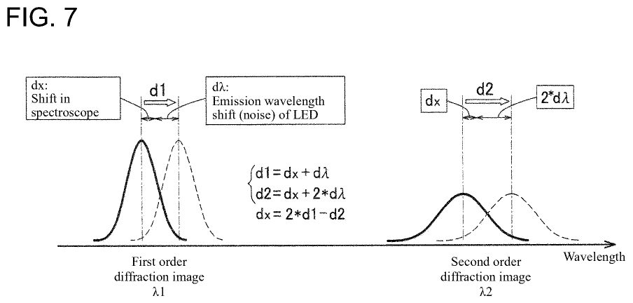

### DESCRIPTION OF EMBODIMENTS

Embodiments of the present invention will be described below with reference to the accompanying drawings.

### First Embodiment

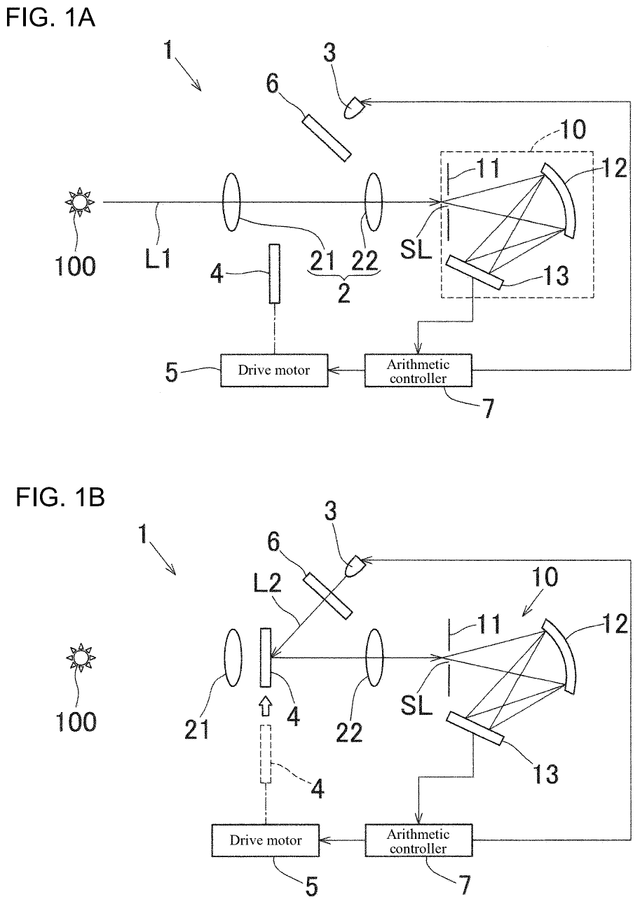

FIG. 1 is a diagram illustrating a configuration of an illuminance spectrophotometer which is an example of a spectroscopic device capable of performing wavelength correction. The illuminance spectrophotometer 1 illustrated in FIG. 1 includes a light-receiving optical system 2 having a front light receiving lens 21 and a rear light receiving lens 22, a correction light source 3, a reflective plate 4, a drive motor 5, an optical filter 6, an arithmetic controller 7, and a polychromator 10 as a spectroscope.

The light-receiving lens optical system 2 guides light L1 of interest to the polychromator 10. The light L1 of interest includes illumination light emitted from a light source 100 to be measured, reflection light from an object to be measured, and the like.

The correction light source 3 is turned on and used at the time of wavelength correction. In the present embodiment, the correction light source 3 is composed of an LED and outputs a monochromatic ray having a variation in wavelength.

The reflective plate 4 is a diffuse reflective plate, and is driven by the drive motor 5 so as to be inserted into or retracted from an optical path of the light L1 of interest at a position that is located between the front lens 21 and the rear lens 22 of the light-receiving optical system 2 and that is closer to the front lens 21. As illustrated in FIG. 1A, the reflective plate 4 is retracted from the optical path of the light L1 of interest during the measurement of the light L1 of interest. In this state, the light L1 of interest passes through the light-receiving optical system 2 and enters the polychromator 10. On the other hand, during the wavelength correction, the reflective plate 4 is driven to advance into the optical path of the light L1 of interest as illustrated in FIG. 1B. In this state, the optical path of the light L1 of interest is interrupted, and the correction light L2 which is emitted from the correction light source 3 and passes through the optical filter 6 is reflected and is guided to the polychromator 10. In this way, the reflective plate 4 and the drive motor 5 function as switching means for switching between guiding the light L1 of interest to the polychromator 10 and guiding the correction light L2 to the polychromator 10.

The optical filter 6 is disposed between the correction light source 3 and the reflective plate 4. In the present embodiment, the optical filter 6 is a bandpass filter that transmits only light of a specific wavelength band, and is formed of a dielectric multilayer film.

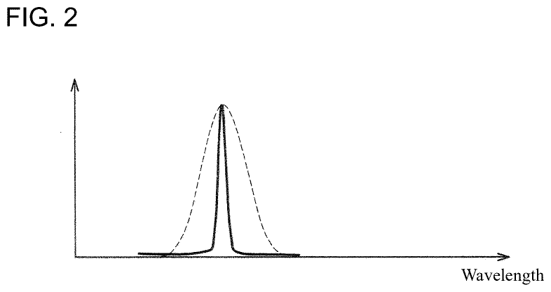

FIG. 2 illustrates an example of an LED emission spectrum of the correction light source 3 and a transmission spectrum of the optical filter 6. A dotted line indicates the LED emission spectrum of the correction light source 3, and a solid line indicates the transmission spectrum of the optical filter 6. When the central wavelength in the band of the LED emission spectrum is brought close to the central wavelength in the band of the optical filter 6, light is used with high efficiency. The peak wavelength of the LED emission spectrum and the peak wavelength of the optical filter 6 are preferably adjusted to be within ±10 nm.

The LED emission spectrum of the correction light source 3 shifts by several nm due to a temperature change. On the other hand, a temperature change of the transmission spectrum of the dielectric multilayer film filter which is the optical filter 6 is sufficiently small and stable, whereby the robustness as the light source can be improved. In addition, by setting the transmission band width of the optical filter 6 to be sufficiently narrower than the half bandwidth of the LED emission spectrum, it is possible to minimize the influence (variation in the position of the center of gravity, etc.) on light passing through the filter when the LED emission spectrum is shifted.

Returning to FIG. 1A and FIG. 1B, the polychromator 10 includes a slit plate 11, a diffraction grating 12, a light receiving sensor array 13, and the like.

An entrance slit SL is formed in the slit plate 11. The number of the entrance slits SL may be one or two or more.

The diffraction grating 12 functions as dispersion means. The diffraction grating 12 reflects and diffuses the light L1 of interest which has passed through the entrance slit SL, or the correction light L2 which has been emitted from the correction light source 3, has passed through the optical filter 6, and has been reflected by the reflective plate 4 to convert the light L1 and the correction light L2 into dispersion images according to wavelengths, and form the dispersion images on the light receiving sensor array 13.

The light receiving sensor array 13 includes a plurality of photoelectric conversion elements (hereinafter, also referred to as sensors) arranged at a predetermined interval, for example, an interval corresponding to about 10 nm in terms of wavelength of the dispersed light. An electric signal corresponding to the intensity of received light output from each sensor is processed by the arithmetic controller 7.

The arithmetic controller 7 includes, for example, a central processing unit (CPU) and an electrically erasable programmable read-only memory (EEPROM). The arithmetic controller 7 allows the correction light L2 to enter the slit SL at the time of wavelength correction, and obtains, as an image shift amount (wavelength shift amount), an amount of change of a light receiving position where the dispersion image dispersed for each wavelength by the diffraction grating 12 is received from an initial position on the light receiving sensor array 13. As will be described later, the influence of the wavelength change of the correction light L2 is removed from the obtained wavelength shift amount. Note that the arithmetic controller 7 performs various kinds of arithmetic processing for wavelength correction, lighting control of the correction light source 3, driving control of the drive motor 5, and the like.

At the time of measurement of the light L1 of interest illustrated in FIG. 1A, the arithmetic controller 7 drives the drive motor 5 to retract the reflective plate 4 from the optical path of the light L1 of interest, so that the light of interest having passed through the light receiving lens system 2 enters the slit SL. The light L1 of interest that has entered is dispersed as dispersion images for respective wavelengths by the diffraction grating 12, and the dispersion images are received by the sensors of the light receiving sensor array 13, respectively. The arithmetic controller 7 performs A/D conversion on the output of each sensor of the light receiving sensor array 13, and measures the spectral intensity.

At the time of wavelength correction illustrated in FIG. 1B, the arithmetic controller 7 drives the drive motor 5 to advance the reflective plate 4 into the optical path of the light L1 of interest, thereby blocking the light L1 of interest, and turns on the correction light source 3. The correction light L2 emitted from the correction light source 3 and passing through the optical filter 6 is reflected on the reflective surface of the reflective plate 4, enters the slit SL, and is then received by the light receiving sensor array 13 as a first order dispersion image formed by the diffraction grating 12. The arithmetic controller 7 performs A/D conversion on the sensor outputs of the light receiving sensor array 13 that has received the first order dispersion image of the correction light L2 and measures the intensity profile.

The first order dispersion image means any one of an image by positive first order diffraction light and an image by negative first order diffraction light with the diffraction grating 12. The wavelength of the first order dispersion image can be defined by any of various known methods such as a centroid wavelength, a Gaussian approximation peak wavelength, and a central wavelength. The same applies to other embodiments to be described later, and also to a second order dispersion image to be described later. The light receiving position where the first order dispersion image is received on the light receiving sensor array 13 at the time of factory shipment is stored in a storage (not illustrated) as an initial position. The arithmetic controller 7 obtains a difference from the light receiving position of the first order dispersion image obtained at the time of wavelength correction after shipment as a wavelength shift amount, and corrects wavelengths based on the shift amount. For example, it is conceivable to use the shift amount as it is as the correction amount.

Even if the wavelength of light from the correction light source 3 shifts due to temperature or the like, the wavelength of the correction light L2 transmitted through the optical filter 6 whose transmission band width is constant becomes also constant without being affected by temperature or the like. Therefore, the wavelength shift amount obtained by the arithmetic controller 7 does not include a wavelength shift caused by a temperature change, but includes only a shift caused by time-dependent and thermal changes in the relative position of the optical elements in the polychromator 10. Therefore, it is possible to obtain a wavelength shift amount with high accuracy, and thus it is possible to perform wavelength correction with high accuracy.

Here, by preparing a plurality of sets of LED as the correction light source 3 and the optical filter 6 with the wavelength being varied, it is possible to obtain shift amounts for a plurality of wavelengths. The wavelength shift amount for each of wavelengths other than the plurality of wavelengths for which the shift amount has been obtained can be estimated by linear interpolation, polynomial interpolation, extrapolation processing, or the like using the obtained wavelength shift amount. Since the shift amounts for the plurality of wavelengths are obtained with high accuracy, the wavelength shift amounts in other wavelength bands are estimated using the obtained shift amounts, whereby wavelength correction with high accuracy is achieved over the entire measurable wavelength range.

Not only the first order dispersion image of the correction light L2 but also a second order dispersion image may be used. For example, when the central wavelength of light transmitted through the optical filter 6 is 375 nm, the first order dispersion image is formed at a position of 375 nm, but the second order dispersion image is formed at a position of 750 nm. Although the wavelength of the second order dispersion image is 375 nm, a variation in the second order dispersion image of light of a wavelength of 375 nm and a variation in the first order dispersion image of light of a wavelength of 750 nm caused by a variation in the dispersion means are the same in a case where the dispersion means of the polychromator 10 is constituted by a reflecting optical system such as a reflection grating or a concave mirror. Therefore, the wavelength shift amount corresponding to two wavelengths can be obtained by one set of the correction light source 3 and the optical filter 6.

Furthermore, a filter having a plurality of transmission bands may be used as the optical filter 6. In this case, the wavelength shift amounts of a plurality of first order dispersion images can be obtained by one optical filter 6.

### Second Embodiment

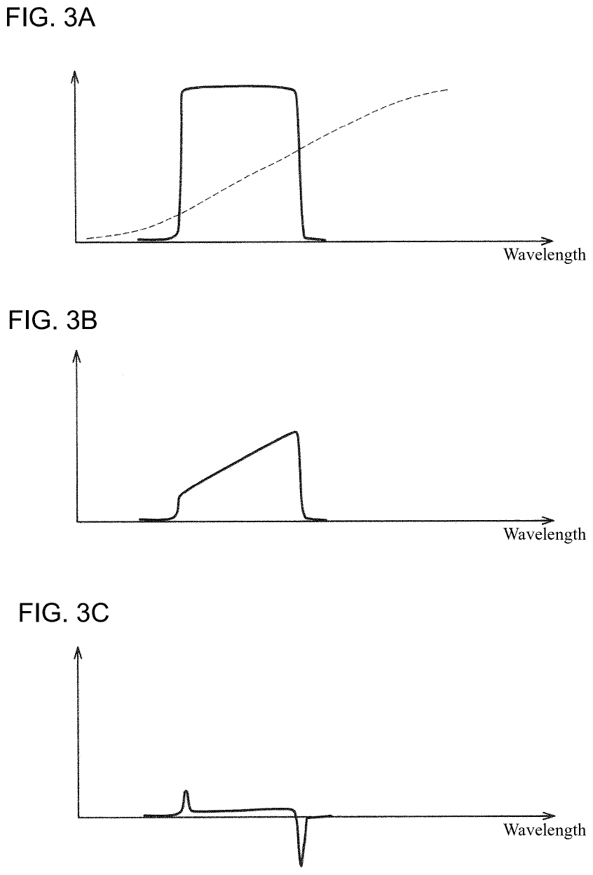

In the present embodiment, a broadband light source such as a halogen lamp or a white LED is used as the correction light source 3. Further, as the optical filter 6, a wideband bandpass filter which transmits only a wavelength of a specific range as indicated by a solid line in FIG. 3A is used. In these respects, the second embodiment is different from the first embodiment. Note that in FIG. 3A, the dotted line indicates the emission spectrum of the correction light source 3.

As illustrated in FIG. 3B, the spectrum of correction light L2 transmitted through the optical filter 6, which is a wideband bandpass filter, is acquired by a light receiving sensor array 13 of a polychromator 10. Then, as illustrated in FIG. 3C, a filter cut wavelength is obtained by performing differential processing or the like on the acquired spectrum, and the filter cut wavelength is set as a light receiving position where a dispersion image is received. Then, the difference between the light receiving position and an initial position that is determined as the position of a cut wavelength at the time of factory shipment is determined as a wavelength shift amount as in the first embodiment.

The wavelength shift amounts of the two wavelengths corresponding to the filter cut wavelength can be obtained by one set of the correction light source 3 and the optical filter 6. If the second order dispersion image is also used for each wavelength, the wavelength correction amounts for the four wavelengths can be obtained, and more correction information can be obtained. In addition, a plurality of correction light sources 3 and optical filters 6 may be set, and the wavelength shift amounts of two wavelengths corresponding to the filter cut wavelengths of the respective optical filters 6 may be obtained. Also, a second order dispersion image may be used for each wavelength.

### Third Embodiment

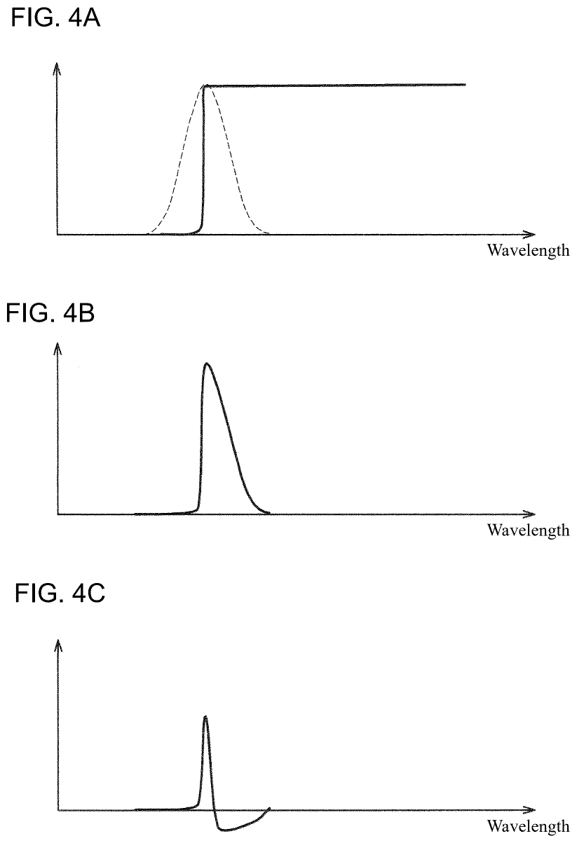

The present embodiment is different from the second embodiment in that a sharp cut filter having a characteristic of cutting off light having a certain wavelength (cut wavelength) or shorter as illustrated in FIG. 4A is used as an optical filter 6. Note that in FIG. 4A, the dotted line indicates the emission spectrum of a correction light source 3.

The central wavelength of an LED that is the correction light source 3 is brought close to the cut wavelength. As illustrated in FIG. 4B, the spectrum of correction light L2 transmitted through the optical filter 6, which is a sharp cut filter, is acquired by a light receiving sensor array 13 of a polychromator 10. Then, as illustrated in FIG. 4C, a cut wavelength is obtained by performing differential processing or the like on the acquired spectrum, and the cut wavelength is set as a light receiving position where a dispersion image is received. Then, the difference between the light receiving position and an initial position that is determined as the position of a cut wavelength at the time of factory shipment is determined as a wavelength shift amount as in the first embodiment.

In this case, it is also possible to obtain wavelength shift amounts for a plurality of wavelengths by preparing a plurality of sets of LED as the correction light source 3 and the optical filter 6 with the cut wavelength being varied. In addition, if a second order dispersion image can be used in addition to a first order dispersion image, the number of sets of the correction light source 3 and the optical filter 6 can be reduced.

### Fourth Embodiment

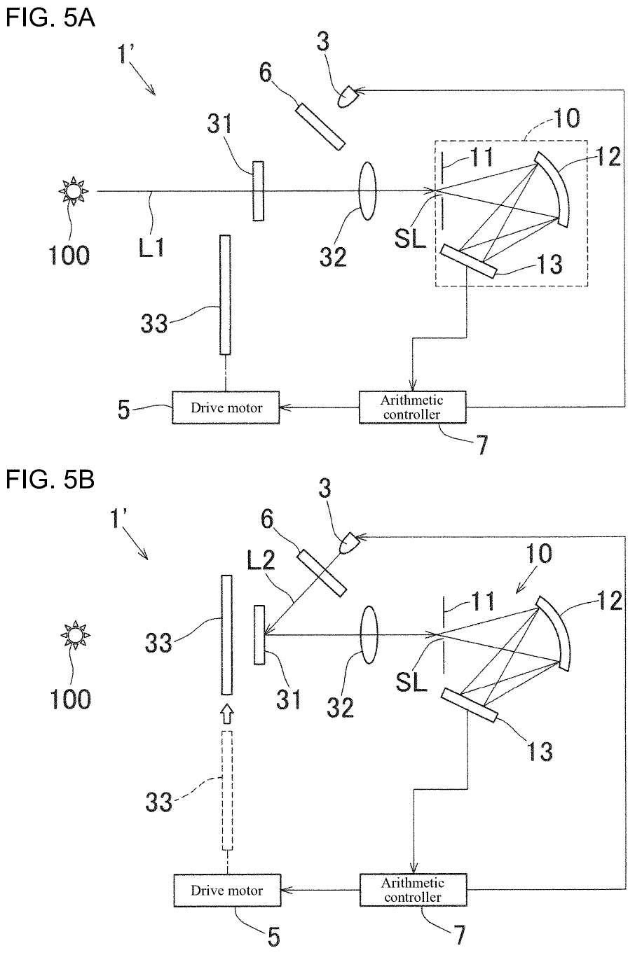

FIG. 5A and FIG. 5B are diagrams illustrating a configuration of a spectroradiometer 1′ which is another example of a spectroscopic device capable of performing wavelength correction.

The spectroradiometer 1′ includes a light receiving/diffusing plate 31 that receives and diffuses light L1 of interest from a light source 100 to be measured. The light L1 of interest that has passed through the light receiving/diffusing plate 31 passes through a lens 32 and enters a slit SL of a polychromator 10.

Further, the reflective plate 4 which can be inserted into or retracted from the optical path of the light L1 of interest and the front lens 21, both of which are provided in the first embodiment illustrated in FIG. 1A and FIG. 1B, are not provided. The correction light L2 which is emitted from the correction light source 3 and is transmitted through the optical filter 6 can be applied to the light receiving/diffusing plate 31.

In the present embodiment, a light shielding member 33 is further provided. The light shielding member 33 is driven by a drive motor 5 so as to be advanced to or retracted from the optical path of the light L1 of interest at a position on the upstream side of the light receiving/diffusing plate 31. The light shielding member 33 is retracted from the optical path of the light L1 of interest as illustrated in FIG. 5A during measurement of the light L1 of interest, and the light L1 of interest passes through the light receiving/diffusing plate 31 and enters the slit SL of the polychromator 10. On the other hand, during the wavelength correction, the light shielding member 33 is driven to be advanced to the optical path of the light L1 of interest as illustrated in FIG. 5B. In this state, the optical path of the light L1 of interest is blocked so that the light L1 of interest does not enter the light receiving/diffusing plate 31. The correction light L2 which is emitted from the correction light source 3 and passes through the optical filter 6 is reflected and diffused on the light receiving/diffusing plate 31 and is guided to the slit SL of the polychromator 10. That is, the light L1 of interest and the correction light L2 are switched between at the time of measurement of the light L1 of interest and at the time of wavelength correction, and the switched light is guided to the slit SL of the polychromator 10.

Note that the configurations of the correction light source 3, the drive motor 5, the optical filter 6, the arithmetic controller 7, and the polychromator 10 are the same as those in the embodiment illustrated in FIG. 1A and FIG. 1B. The operation of calculating a wavelength correction amount by the arithmetic controller 7 is also the same as that in the first embodiment.

### Fifth Embodiment

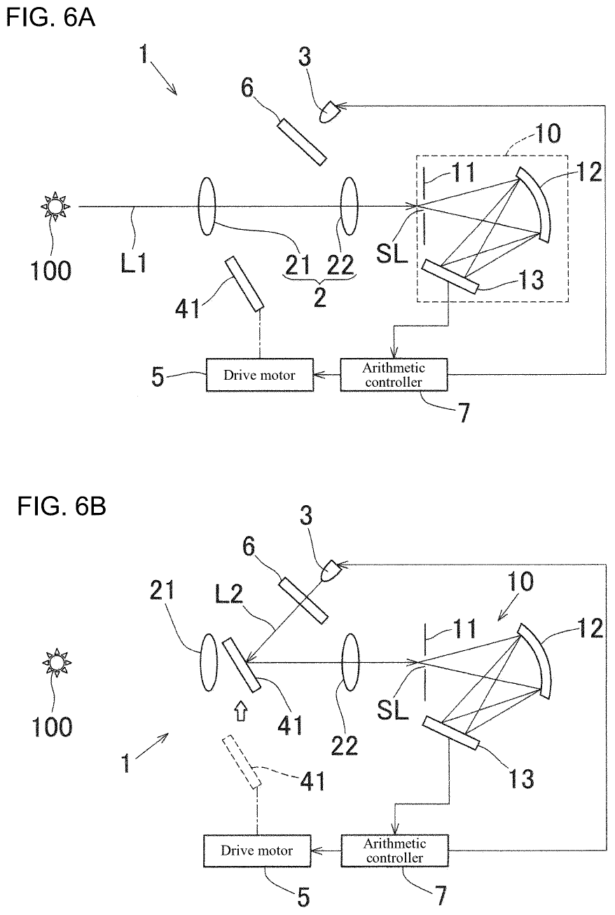

As illustrated in FIG. 6, this embodiment has the same configuration as that of the first embodiment except that the reflective plate (diffuse reflective plate) 4 in the first embodiment is replaced with a mirror 41 and the positions of the correction light source 3 and the entrance slit SL are in a conjugate relation.

During measurement of light L1 of interest illustrated in FIG. 6A, the drive motor 5 retracts the mirror 41 from the optical axis of the light L1 of interest. During wavelength correction illustrated in FIG. 6B, the drive motor 5 advances the mirror 41 to the optical axis of the light L1 of interest. Thus, the correction light L2 is regularly reflected by the mirror and enters the polychromator 10. That is, the light L1 of interest and the correction light L2 are switched between at the time of measurement of the light L1 of interest and at the time of wavelength correction, and the switched light is guided to the slit SL of the polychromator 10.

In the present embodiment, the operation of calculating a wavelength shift amount by the arithmetic controller 7 is the same as that in the first embodiment.

In the embodiment in FIG. 5A and FIG. 5B, the required accuracy of the position and the orientation of the mirror 41 increases, but the required accuracy can be lowered by inserting a diffusion plate between the optical filter 6 and the mirror 41.

While one embodiment of the present invention has been described above, the present invention is not limited to the above-described embodiment. For example, the optical filter 6 is disposed between the correction light source 3 and the reflective plate 4, the light receiving/diffusing plate 31, or the mirror 41. However, the optical filter 6 may be disposed at a position between the reflective plate 4, the light receiving/diffusing plate 31, or the mirror 41 and the lens 22 or the lens 32, or at a position between the lens 22 or the lens 32 and the polychromator 10. In a case where the optical filter 6 is arranged at any of the positions described above, the optical filter 6 is required to be driven together with the reflective plate 4 or the like so that the optical filter 6 is retracted from the optical path of the light L1 of interest at the time of the measurement of the light L1 of interest in order not to affect the measurement of the light L1 of interest and is advanced to the optical path of the light L1 interest at the time of wavelength correction.

As described above, in the present embodiment, even if a wavelength shift occurs due to time-dependent and thermal changes in the relative positions of the optical elements in the polychromator 10, the wavelength shift is corrected, and thus, the wavelength accuracy at the time of initial wavelength calibration can be maintained.

While one embodiment of the present invention has been described above, the present invention is not limited to the above-described embodiment. For example, a configuration has been described in which switching means is driven by a motor or the like to perform switching so that the light L1 of interest enters the entrance slit SL at the time of measurement of the light L1 of interest and the correction light L2 passes through the optical filter 6 and enters the entrance slit SL at the time of wavelength correction. However, the switching may be performed manually, or the optical filter 6 may be moved manually. Furthermore, an entrance hole for introducing the light L1 of interest into the spectroscopic device may be closed by an external cap or the like so that the light L1 of interest does not enter the spectroscopic device 1 at the time of wavelength correction. Alternatively, the correction light source 3 may be disposed outside, and during wavelength correction, light from the correction light source 3 may enter the spectroscopic device, pass through the optical filter 6 disposed inside the spectroscopic device 1, and be guided to the entrance slit SL. Alternatively, the correction light source 3 and the optical filter 6 may be disposed outside the spectroscopic device 1, and during wavelength correction, the correction light L2 emitted from the correction light source 3 and passing through the optical filter 6 may enter the spectroscopic device 1 and may be guided to the entrance slit SL.

### REFERENCE SIGNS LIST

1 illuminance spectrophotometer (spectroscopic device)
1′ spectroradiometer (spectroscopic device)
2 light receiving lens system
3 correction light source
4 reflective plate
5 drive motor
6 optical filter
7 arithmetic controller
10 polychromator
11 slit plate
12 diffraction grating
13 light receiving sensor array
31 light receiving/diffusing plate
33 light shielding member
41 reflecting mirror
SL slit

1. A spectroscopic device comprising:
at least one correction light source;
at least one optical filter that transmits a light ray of a specific wavelength band among light rays from the correction light source;
at least one entrance slit on which light of interest and correction light that has been emitted from the correction light source and has passed through the optical filter are incident;
a dispersion section that disperses, into dispersion images for each wavelength, the light of interest that has passed through the entrance slit during measurement of the light of interest and the correction light that has passed through the entrance slit during wavelength correction;
a light receiving sensor that receives the dispersion images for each wavelength by the dispersion section and outputs an electric signal corresponding to an intensity of received light; and
an arithmetic section that, during the wavelength correction, obtains a shift amount of a light receiving position where the dispersion image based on the correction light is received from an initial position on the light receiving sensor and corrects wavelength based on the shift amount.

2. The spectroscopic device according to claim 1, wherein the arithmetic section—obtains a shift amount for another wavelength from a shift amount of a light receiving position where each of a plurality of dispersion images is received from an initial position on the light receiving sensor for one or a plurality of the correction light sources.

3. The spectroscopic device according to claim 1, wherein the arithmetic section obtains a shift amount for another wavelength from a shift amount of a light receiving position where a first order dispersion image is received from an initial position on the light receiving sensor and a shift amount of a light receiving position where a second order dispersion image is received from an initial position on the light receiving sensor for one or a plurality of the correction light sources.

4. The spectroscopic device according to claim 1, wherein the optical filter is a bandpass filter having at least one spectral transmission band.

5. The spectroscopic device according to claim 1, wherein the optical filter is a sharp cut filter.

6. The spectroscopic device according to claim 4, wherein the arithmetic section determines a light receiving position of any one of a peak wavelength, a central wavelength, and a centroid wavelength of the spectral transmission band as the light receiving position where the dispersion image is received.

7. The spectroscopic device according to claim 4, wherein the arithmetic section determines a light receiving position of a cut wavelength of the spectral transmission band as the light receiving position where the dispersion image is received.

8. The spectroscopic device according to claim 5, wherein the arithmetic section determines a light receiving position of a cut wavelength of the sharp cut filter as the light receiving position where the dispersion image is received.

9. The spectroscopic device according to claim 1, further comprising a switcher that allows the light of interest to enter the entrance slit during the measurement of the light of interest and allows the correction light to enter the entrance slit during the wavelength correction.

10. The spectroscopic device according to claim 9, further comprising
a reflective plate disposed so as to be freely inserted into and retracted from an optical path of the light of interest entering the entrance slit, wherein
the switcher retracts the reflective plate from the optical path of the light of interest during the measurement of the light of interest and advances the reflective plate into the optical path of the light of interest during the wavelength correction so that the correction light is reflected by the reflective plate to the entrance slit.

11. The spectroscopic device according to claim 10, wherein the reflective plate is a diffuse reflective plate or a mirror.

12. The spectroscopic device according to claim 9, further comprising:
a light receiving/diffusing plate disposed in an optical path of the light of interest entering the entrance slit, the light receiving/diffusing plate transmitting the light of interest and diffusing and reflecting the correction light; and a light shielding plate disposed so as to be freely inserted into and retracted from the optical path of the light of interest at an upstream side of the light receiving/diffusing plate, wherein
the switcher retracts the light shielding plate from the optical path of the light of interest during the measurement of the light of interest and advances the light shielding plate into the optical path of the light of interest during the wavelength correction.

13. A wavelength correction method comprising:
transmitting a light ray of a specific wavelength band among light rays from at least one correction light source through at least one optical filter;
allowing light of interest to enter at least one entrance slit during measurement of the light of interest and allowing correction light that has been emitted from the correction light source and has transmitted through the optical filter to enter the entrance slit during wavelength correction;
dispersing the light of interest or the correction light passing through the entrance slit into dispersion images for each wavelength;
receiving the dispersed dispersion images for each wavelength by a light receiving sensor and outputting an electric signal corresponding to an intensity of received light; and
obtaining a shift amount of a light receiving position where the dispersion image based on the correction light is received from an initial position on the light receiving sensor during the wavelength correction, and correcting wavelength based on the shift amount.

14. The wavelength correction method according to claim 13, further comprising obtaining a shift amount for another wavelength from a shift amount of a light receiving position where each of a plurality of dispersion images is received from an initial position on the light receiving sensor for one or a plurality of the correction light sources.

15. The wavelength correction method according to claim 13, further comprising obtaining a shift amount for another wavelength from a shift amount of a light receiving position where a first order dispersion image is received from an initial position on the light receiving sensor and a shift amount of a light receiving position where a second order dispersion image is received from an initial position on the light receiving sensor for one or a plurality of the correction light sources.

16. The wavelength correction method according to claim 13, wherein the optical filter is a bandpass filter having at least one spectral transmission band.

17. The wavelength correction method according to claim 13, wherein the optical filter is a sharp cut filter.

18. The wavelength correction method according to claim 16, wherein further comprising determining a light receiving position of any one of a peak wavelength, a central wavelength, and a centroid wavelength of the spectral transmission band as the light receiving position where the dispersion image is received.

19. The wavelength correction method according to claim 16, further comprising determining a light receiving position of a cut wavelength of the spectral transmission band as the light receiving position where the dispersion image is received.

20. The wavelength correction method according to claim 17, further comprising determining a light receiving position of a cut wavelength of the sharp cut filter as the light receiving position where the dispersion image is received.

21. The wavelength correction method according claim 13, further comprising allowing the light of interest to enter the entrance slit during the measurement of the light of interest and allowing the correction light to enter the entrance slit during the wavelength correction.

22. The wavelength correction method according to claim 21, wherein
the spectroscopic device includes a reflective plate disposed so as to be freely inserted into and retracted from an optical path of the light of interest entering the entrance slit, the method further comprising
retracting the reflective plate from the optical path of the light of interest during the measurement of the light of interest and advancing the reflective plate into the optical path of the light of interest during the wavelength correction so that the correction light is reflected by the reflective plate to the entrance slit.

23. The wavelength correction method according to claim 22, wherein the reflective plate is a diffuse reflective plate or a mirror.

24. The wavelength correction method according to claim 21, wherein
the spectroscopic device includes: a light receiving/diffusing plate disposed in an optical path of the light of interest entering the entrance slit, the light receiving/diffusing plate transmitting the light of interest and diffusing and reflecting the correction light; and a light shielding plate disposed so as to be freely inserted into and retracted from the optical path of the light of interest at an upstream side of the light receiving/diffusing plate, and the method further comprising
retracting the light shielding plate from the optical path of the light of interest during the measurement of the light of interest and advancing the light shielding plate into the optical path of the light of interest during the wavelength correction.
